(19) United States
(12) Patent Application Publication
(10) Pub. No.: US 2003/0223576 A1
(43) Pub. Date: Dec. 4, 2003

(54) Portable telephone

(76) Inventor: Hideo Totani, Mashita-gun (JP)

Correspondence Address: Ronald E. Greigg, Greigg & Greigg, P.L.L.C., Unit One, 1423 Powhatan Street, Alexandria, VA, 22314, US

(21) Appl. No.: 10/449,097

(22) Filed: Jun. 2, 2003

(30) Foreign Application Priority Data
Aug. 22, 2002 (JP) P2002-241631
Jun. 3, 2002 (JP) P2002-161490

(51) Int. Cl. H04M 1/00; H04M 9/00

(52) U.S. Cl. 379/433.04; 379/433.01

(57) ABSTRACT

A portable telephone with an input operation part and a lengthwise liquid crystal display part includes the liquid crystal display (LCD) part pivots at a support part which connected to a telephone body; a display screen of the LCD part, capable of seeing as a longwise display screen when the LCD part rotates at 90 degrees; the information indicated on the longwise display screen; a CPU which receives a detected signal detected by the detection circuit; and a drive circuit which receives a control signal from the CPU and which drives information elements to the LCD so as to indicate an information position and setup menu correctly corresponding to the display screen. Therefore, the lengthwise display screen of the portable telephone is also used as the lengthwise display screen thereof, and it can be applied by a rational composition to the portable telephone that has usually used.

### BACKGROUND OF THE INVENTION

This invention relates to a portable telephone.

In recent years, the portable telephones, such as PHS and i-mode (registered trademark), have spread. Since it is necessary for the form of portable telephone to form the size which can generally put on a palm in relation to use, the form and the size of the display screen of a liquid crystal display also are restricted. The kind of the portable telephones can be classified roughly into a straight type which the liquid crystal display is arranged at au upper portion of an input operation part and a folding type which the liquid crystal display part is provided with the input operation part integrally. The folding portable telephones have the lengthwise display screens, and the size of its display screen is larger than that of the straight-typed portable telephones. However, the size of information (character, figure, etc.) is small so that it is hard for the users to see or read such information because of such reason.

### SUMMARY OF HE INVENTION

Accordingly, it is an object of the invention to provide a portable telephone that the lengthwise display screen of the portable telephone is also used as the longwise display screen thereof. It is another object of the invention to provide a portable telephone that can indicate the information position and setting menu correctly and automatically corresponding to the longwise display screen by controlling one operation key when the lengthwise display screen is used as the longwise display screen. It is further object of the invention to provide a portable telephone that can be applied by rational composition to the portable telephone that has usually used.

A portable telephone of the present invention with an input operation part located at a lower part thereof and a lengthwise liquid crystal display part located at an upper part thereof, characterizes the liquid crystal display part pivots at a support part which connected to a base plate part of a telephone body; a display screen of the liquid crystal display part, capable of seeing as a longwise display screen when the liquid crystal display part rotates to a horizontal direction at approximately 90 degrees via a pivotable shaft; and an information indicated visibly on the longwise display screen which is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

In addition, A portable telephone characterizes a telephone body having a base plate part which is located below a pivot part, capable of putting a palm on and a cover support part which is located above the pivot part, opening and closing to the base plate part; an input operation part provided at the base plate part; a liquid crystal display part which is pivoted on an inner wall of the cover support part, provided a lengthwise display screen as a normal position and a longwise display screen when the liquid crystal display part is rotated at approximately 90 degrees via a pivotable shaft; a necessary circuit for the telephone; characterized in that the longwise display screen indicates information is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

Moreover, a portable telephone with an input operation part located at a lower part thereof and a lengthwise liquid crystal display part located at an upper part thereof through a pivot part, capable of opening and closing, characterizes one of the input operation part which is provided rotatably in the base plate part of a telephone body through a pivotable shaft and the telephone body which is provided rotatably to the input operation part; the lengthwise liquid crystal display part with a display screen, capable of seeing as a longwise display screen when the liquid crystal display part is rotated at approximately 90 degrees via a pivotable shaft; and characterized in that the longwise display screen indicates information is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

Furthermore, a portable telephone with an input operation part located at a lower part thereof and a lengthwise liquid crystal display part located at an upper part thereof, characterizes the liquid crystal display part which pivots at one end portion of a support member which is supported pivotably by a base plate part of a telephone body; a display screen of the liquid crystal display part, capable of seeing as a longwise display screen when the liquid crystal display part rotates to a horizontal direction at approximately 90 degrees via a pivotable shaft; and an information indicated visibly on the longwise display screen which is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

### BRIEF DESCRIPTION OF THE DRAWINGS

FIGS. 1 to 5 illustrate each schematic explanation view showing a first embodiment of the present invention.

FIGS. 6 to 9 illustrate each schematic explanation view showing a second embodiment of the present invention.

FIGS. 10 to 12 illustrate each schematic explanation view showing a third embodiment of the present invention. FIGS. 13 to 16 illustrate each schematic explanation view showing a fourth embodiment of the present invention.

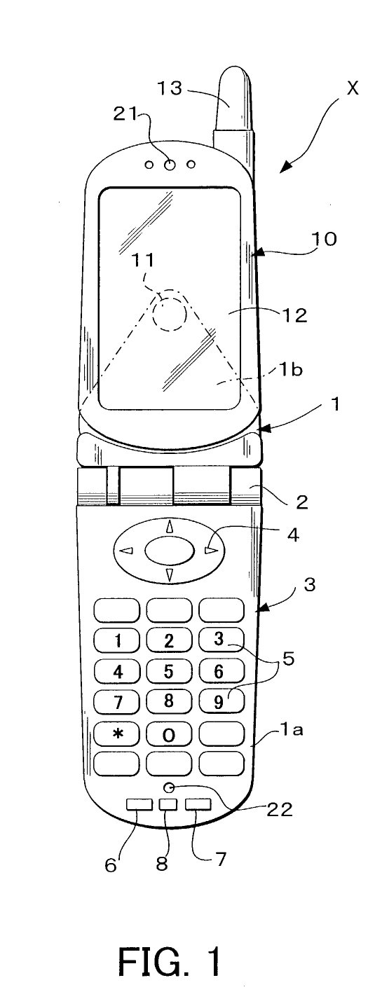

FIG. 1 shows a front explanation view (opening state of the phone);

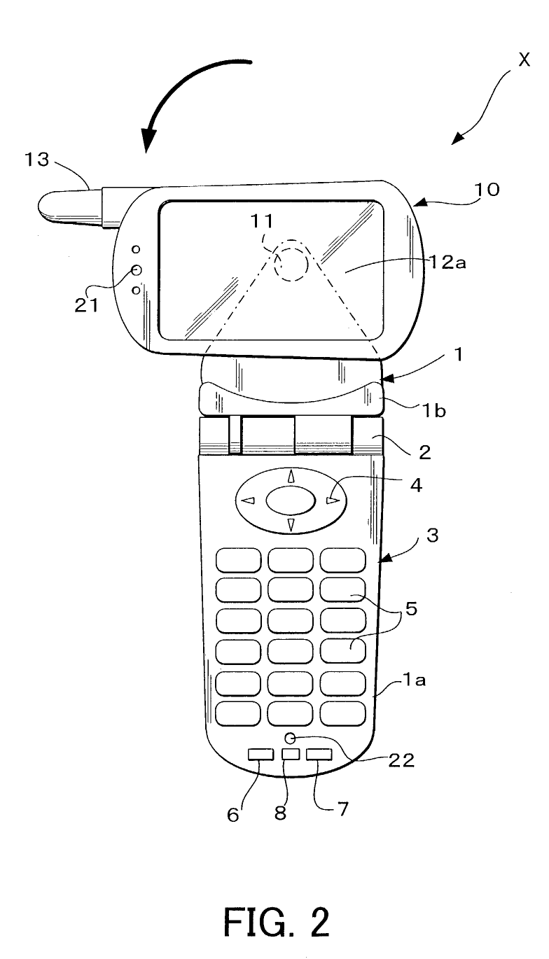

FIG. 2 is an explanation view in front when a liquid crystal display part is turned to a left direction;

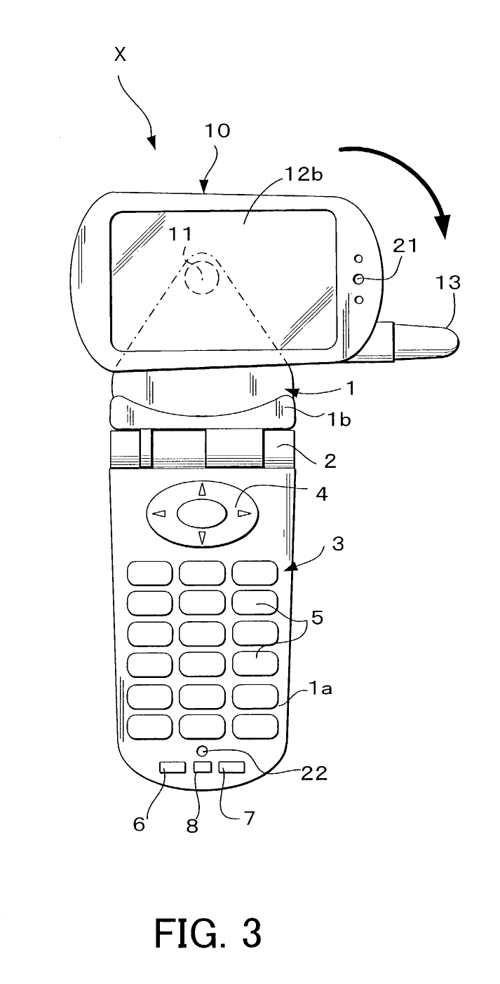

FIG. 3 is a front explanation view when a liquid crystal display part is turned to a right direction;

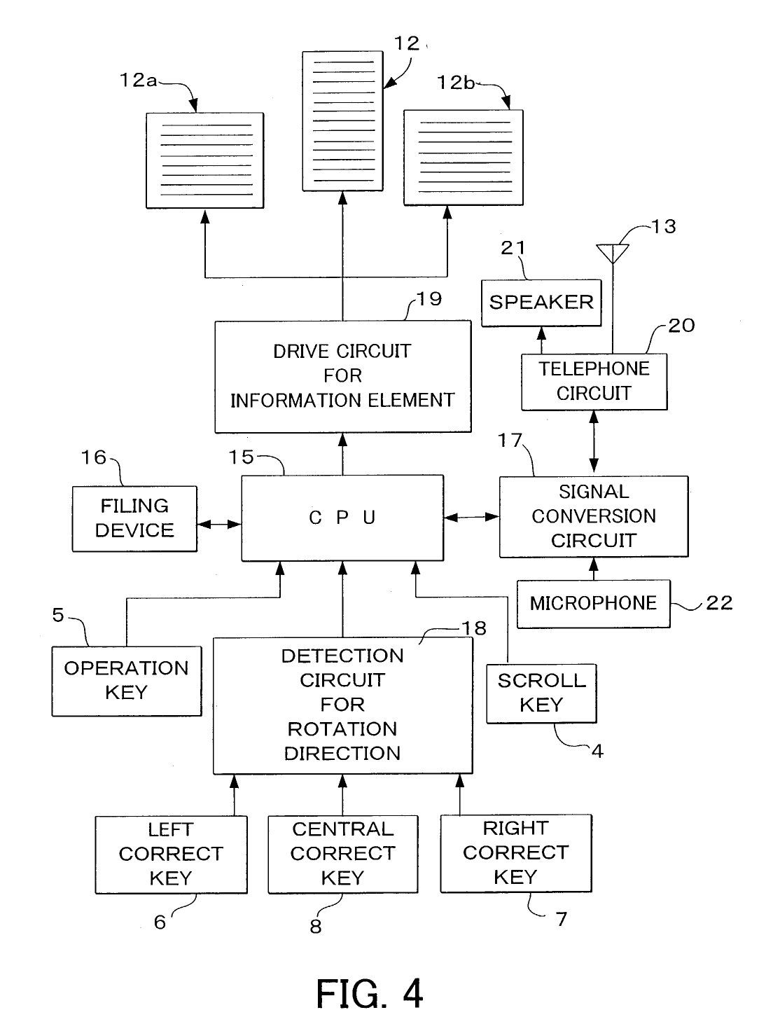

FIG. 4 is an explanation view of an inner circuit of a telephone;

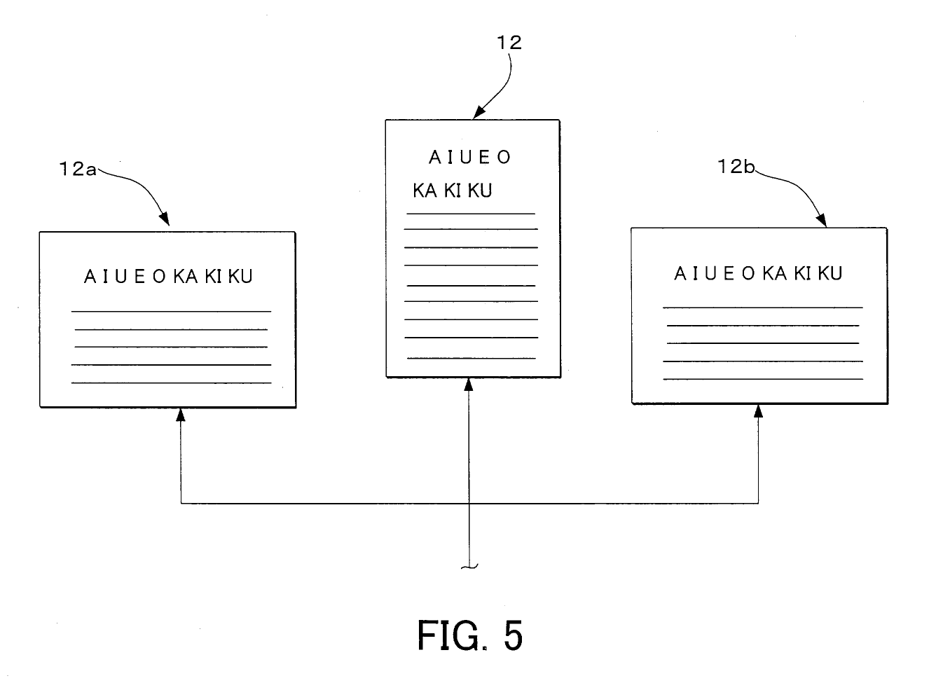

FIG. 5 is an explanation view showing the way in which information is indicated on a longwise display when a liquid crystal display part is turned;

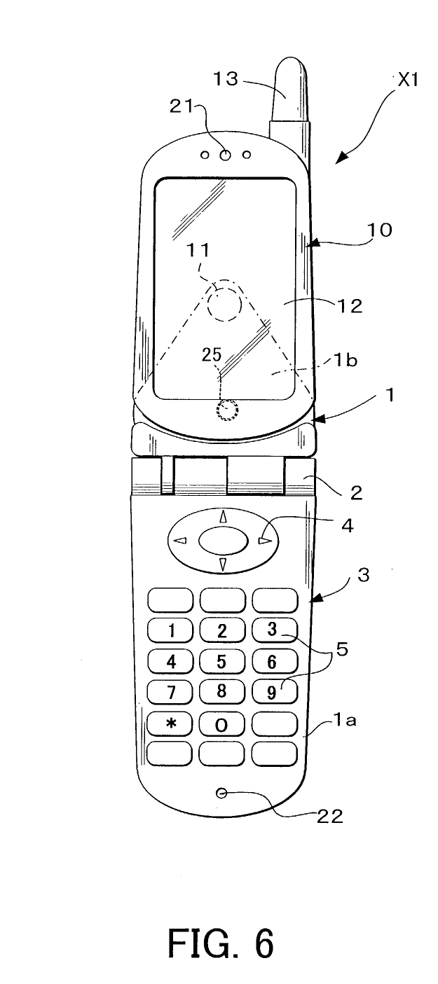

FIG. 6 is a front explanation view showing a second embodiment of the present invention;

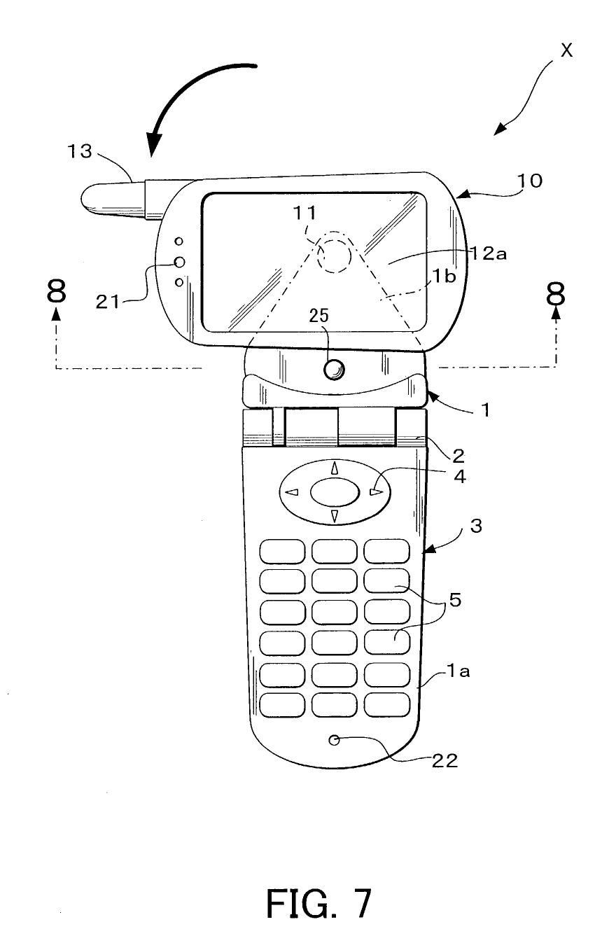

FIG. 7 is a front explanation view when a liquid crystal display part is turned to a left direction;

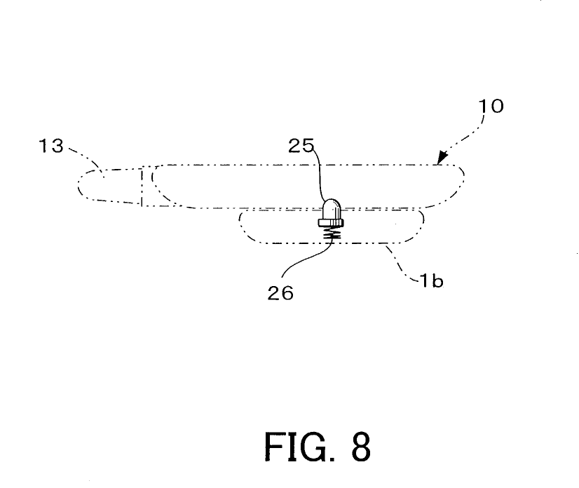

FIG. 8 is a cross section view taken along the line 8-8 of FIG. 7;

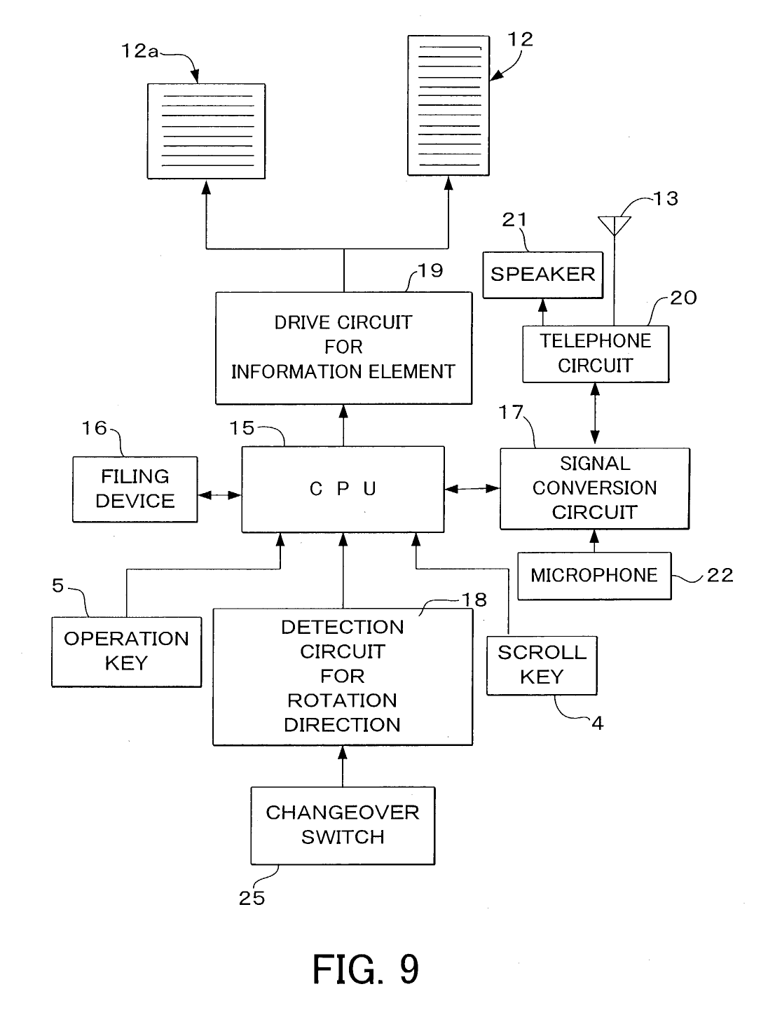

FIG. 9 is an explanation view of an inner circuit of a telephone;

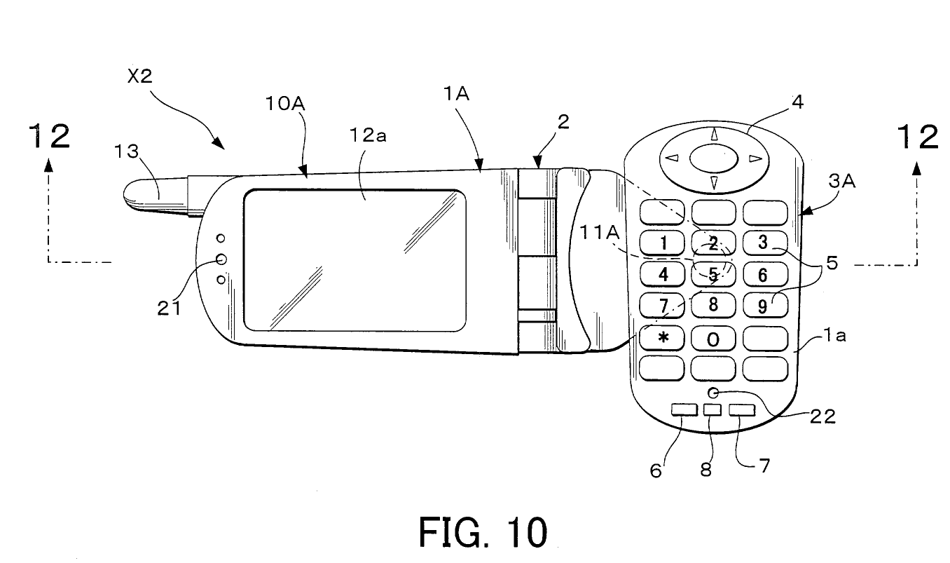

FIG. 10 is an explanation view showing the way in which a display screen of the phone is positioned at a longwise state in a third embodiment and it is operated by a right hand;

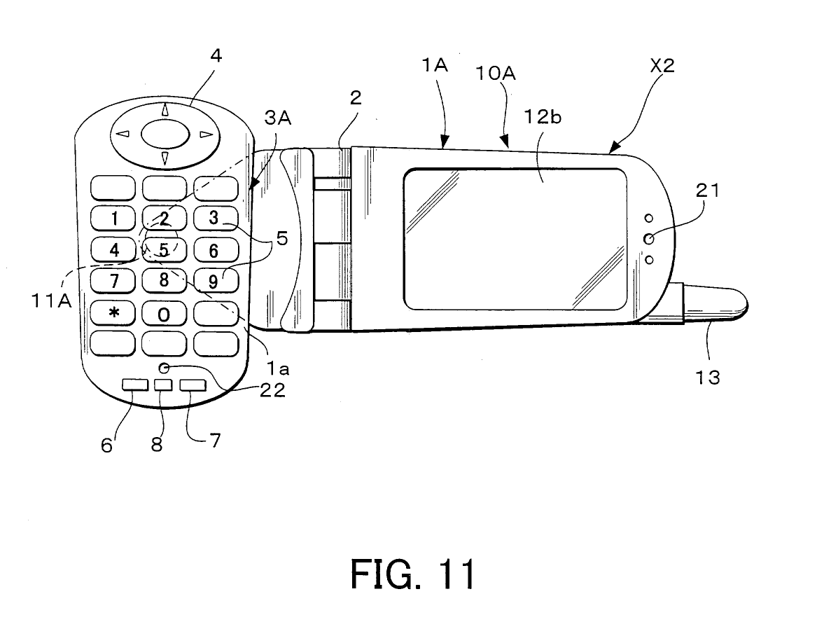

FIG. 11 is an explanation view showing the way in which a display screen of the phone is positioned at a longwise state in a third embodiment and it is operated by a left hand;

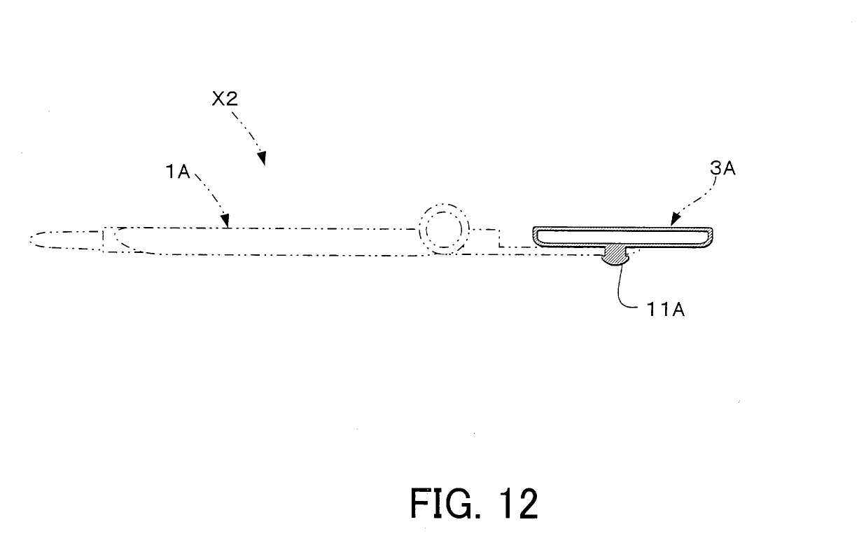

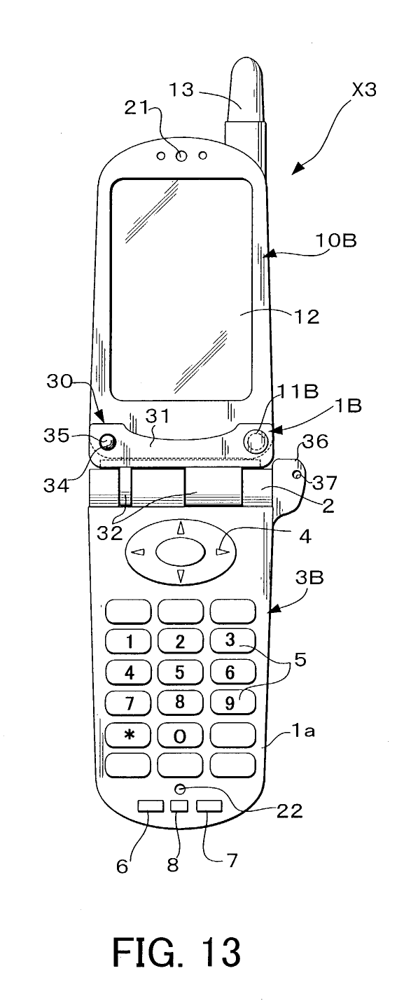

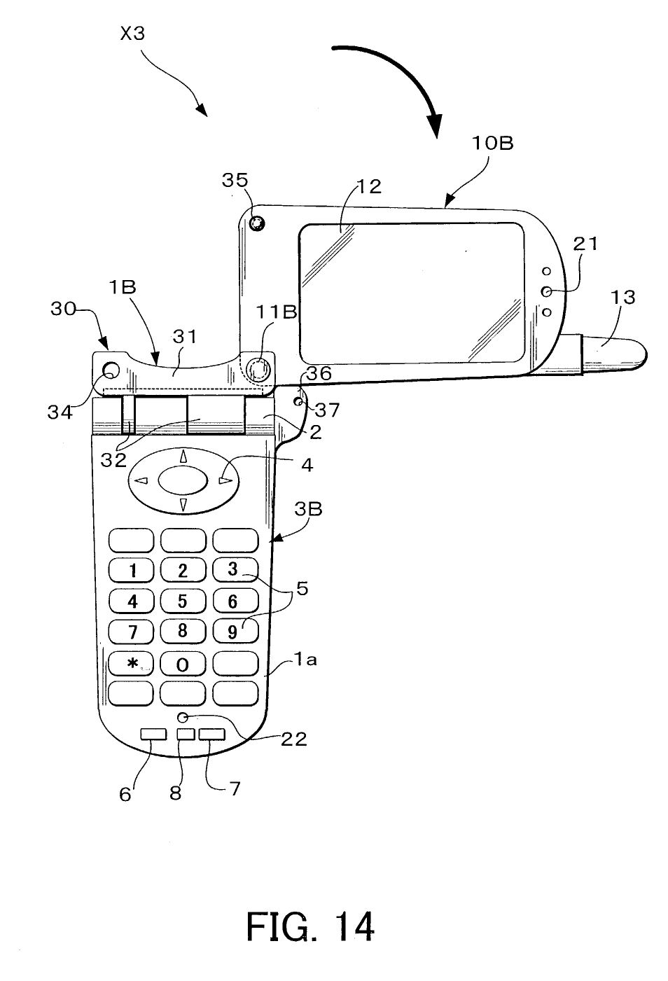

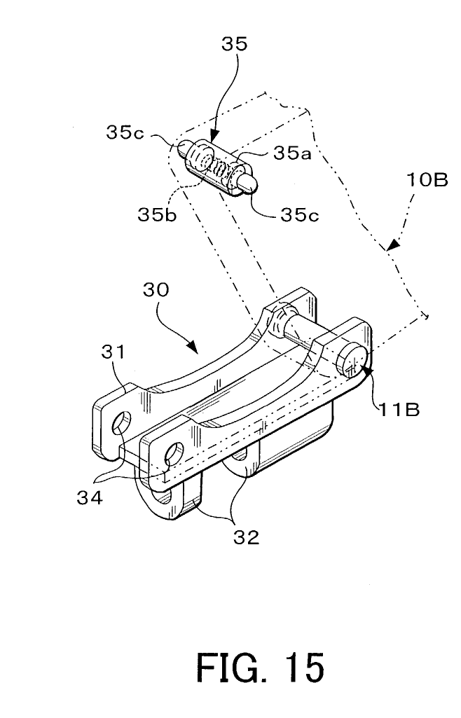

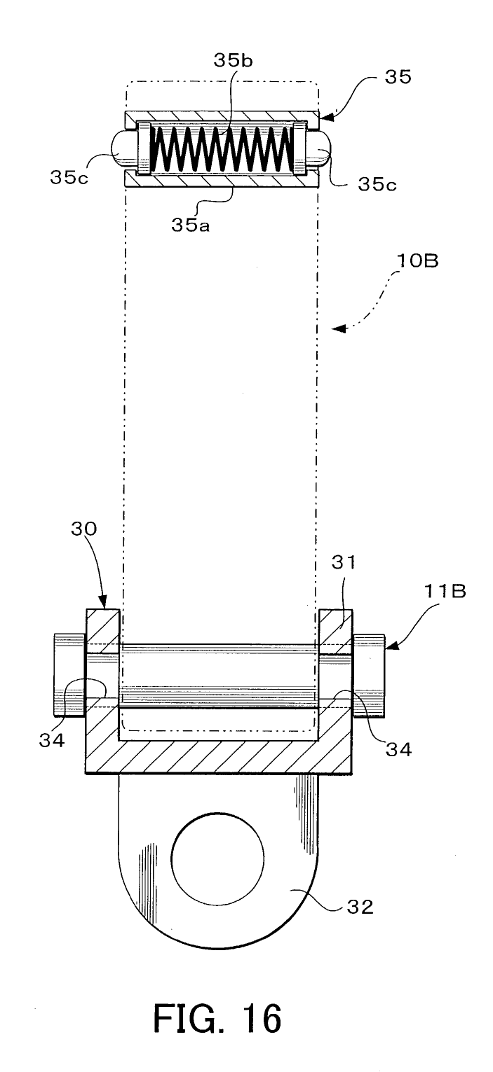

FIG. 12 is a schematic explanation view of a main part of the present invention;

FIG. 13 is a front explanation view in a fourth embodiment (opening state of the phone);

FIG. 14 is a front explanation view when a liquid crystal display part is turned to a right direction;

FIG. 15 is a perspective view of the main parts (support member, means for engaging and the like) of the present invention; and

FIG. 16 is a schematic cross sectional view of the main parts (support member, means for engaging and the like).

### DETAILED DESCRIPTION OF THE PREFERRED EMBODIMENTS

Preferred embodiments of the present invention are described in more detail below with reference to the accompanying drawings.

An understanding of the present invention may be best gained by reference to FIGS. 1-5. At first, a portable telephone X is explained based on FIG. 1. The basic form of the portable telephone can be classified roughly into a straight type which the liquid crystal display is arranged at au upper portion of an input operation part and a folding type which the liquid crystal display part is provided with the input operation part as one through the pivot part which is positioned at the central part thereof. The portable telephone X of the first embodiment belongs to the latter type basically.

That is, the numeral 1 shows a lengthwise telephone body. Th telephone body 1 is comprised of a base plate part 1a which is located below a pivot part 2, capable of putting a palm on and a cover support part 1b with a mountain shape which is located above the pivot part 2, opening and closing to the base plate part 1a. The numeral 3 shows an input operation part provided at an upper surface of the base plate part 1a integrally. A scroll key 4 (pointing device) used for the direction of the cursor (pointer) and the selection of menu which are indicated on a display screen is formed in the upper part of the surface of the input operation part 3. Moreover, a plurality of operation keys 5 (for example, 18 pieces) including a power key, number keys, selection keys and the like, are formed in the lower part of the scroll key 4 of the input operation part 3 at an alignment state (for example, three sequences).

Furthermore, a pair of correct keys 6 and 7 for controlling the information element is positioned at a lower portion of the operation key 5 of the input operation part 3. Moreover, a central correct key 8 for information element control is positioned between the correct key 6 and 7.

These correct keys 6, 7 and 8 are used for inverting and forming so as to read easily the information (for example, text, figure information, etc.) that is indicated on the display screen mentioned later. In this embodiment, the correct key 6 is used when a liquid crystal display part 10 rotates to a left direction (counterclockwise rotation); the scroll key 7 is used when the liquid crystal display part 10 rotates to a right direction (clockwise rotation); and the correct key 8 is used when the liquid crystal display part 10 returned to an initial state (when it returns to a lengthwise display screen 12 from longwise display screens 12a and 12b).

The numeral 10 shows the liquid crystal display part which is provided rotatably through a pivotable shaft 11 on an inner wall of the cover support part 1b. The lengthwise display screen 12 is installed in the surface of the liquid crystal display part 10 as a normal position. In this embodiment, the liquid crystal display part 10 can rotate at approximately 90 degrees to the left direction on the basis of the pivotable shaft 11 (see FIG. 2) and can rotate at approximately 90 degrees to the right direction (see FIG. 3). When the liquid crystal display part 10 is rotated by hand to the right and left directions, the lengthwise display screen 12 changes to the longwise display screens (commonly “wide screen” state) 12a and 12b.

The numeral 13 shows an antenna extensibly formed at an upper right end of the liquid crystal display part 10. In addition, the input and output power terminal, a speaker, a microphone and other apparatus etc. are suitably installed in the portable telephone X. Then, the antenna 13 may be installed in the cover support part 1b or base plate part 1a according to the design.

FIG. 4 illustrates the diagram showing the circuit installed in the portable telephone X. The numeral 15 shows a central processing unit (CPU), and various kinds of circuits and devices connects to the CPU 15 electrically.

Namely, the numeral 16 shows a filing device which memorizes information and a main program; the numeral 17 shows a signal conversion circuit which can transmit and receive the signal; the numeral 18 shows a detection circuit which detects the rotation direction of the liquid crystal display part 10 of the telephone X; and the numeral 19 shows a drive circuit for the information element. The drive circuit includes a function to reverse the information indicated on the display screen, a function to set the number of characters, the number of lines, etc. corresponding to the screen display (lengthwise or longwise display) and a function to specify the direction of the cursor.

A speaker 21 formed in the upper part of the liquid crystal display part 10 connects to a telephone circuit 20, and a microphone 22 formed in the lower part of the input operation part 3 connects to the signal conversion circuit 17.

Then, the signal based on the operation of the scroll key 4 or operation key 5 flows to the CPU 15.

Moreover, the detected signal that the rotation direction detection circuit 18 detected based on the correct key 6 and 7 flows to the CPU 15. Furthermore, the conversion signal that is received with the antenna 13 and changed respectively through the telephone circuit 20 and the signal conversion circuit 17 flows to the CPU 15.

In the above-mentioned portable telephone X, when the user changes and rotates from the lengthwise display screen 12 to the longwise display screen 12a (12b), the liquid crystal display part 10 is rotated by hand at about 90 degrees to the right or left direction. In this case, the characters of the operation key 5 and the characters of the longwise display screen 12a (or 12b) intersect.

That is, it is too hard to read and see the information such as letters, figures and the like because the information indicated on the longwise display screen lies down. Therefore, the user pushes the left or right correct key 6 (7). For example, when the left correct key 6 is pushed, the detection circuit 18 detects the input signal of the left correct key 6, and the detection signal is transmitted to the CPU 15.

When the CPU 15 receives the detection signal of “rotation to the left direction” from the detection circuit 18, the control signal based on the detection signal is transmitted to the drive circuit 19 for the information element.

The drive circuit 19 controls the information element so that information including the text information, figure information and image information is correctly displayed on the wide screen 12a as the longwise display screen that is moved from the lengthwise display screen 12.

The drive circuit 19 for the information element has functions as follows: (a) function to reverse the scanning direction of the liquid crystal display part which does not shown and position the characters etc. at a vertical (raising) state; (b) function to indicate the number of characters, the number of lines, etc. on the whole screen corresponding to the wide screen 12a when the information is reversed; and (c) function to change that the movement direction of the cursor based on the operation of the scroll key 4 is indicated correctly corresponding to the wide screen.

In addition, when the right scroll key 7 is pushed in the above-mentioned case, the drive circuit 19 controls the information element so as to correctly display the information including the text information, figure information and image information on the wide screen 12b as the longwise display screen is rotated from the lengthwise display screen 12.

In this case, the CPU 15 receives the detection signal of “rotation to the right direction” from the detection circuit 18, and the control signal based on the detection signal transmits to the drive circuit 19. Each function of the drive circuit 19 is the same as that of the above-mentioned functions.

Moreover, when it returns to the lengthwise display screen 12 from the longwise display screen 12a (12b), the central correct key 8 is pushed. When the correct key 8 is pushed, the CPU 15 receives the detection signal of “it returned to the initial state” from the detection circuit 18 and transmits the control signal based on the detection signal to drive circuit 19 for the information element.

FIG. 5 shows briefly the mode of the text information which is indicated on the display screens 12, 12a and 12b by each function of the drive circuit 19.

In the first embodiment, although the liquid crystal display part 10 can rotate to the right and left directions, it is not necessary to rotate to both right and left directions (for example, only left direction). It is enough to rotate either right or left direction if the lengthwise display screen can be used as the longwise display screen. In this case, one of the right scroll key or left scroll key may be just provided.

Moreover, although the plurality of the correct keys 6, 7 and 8 for controlling the information element are arranged in the first embodiment, it is not necessary to arrange the plurality of the correct keys. For example, one scroll key is installed in the input operation part 3 or the liquid crystal display part. When the scroll key is pushed repeatedly, the intermittent drive signal may flow to the detection circuit 18. The intermittent drive signal includes, for example, “the first signal when the left correct key 6 is pushed, the second signal when the right correct key 7 is pushed, and the third signal when the return correct key 8 is pushed”.

Other embodiments of the present invention will now be described with reference to FIGS. 6-16. In FIGS. 6-16, the same components as in the first embodiment described above with reference to FIGS. 6-16 are designated by the same reference numerals and therefore will not be further explained in great detail.

A second embodiment of the present invention is shown in FIGS. 6-9. It is distinguished from the first embodiment in that one changeover switch 25, forming in a push-shape, for the information element is installed in the lower central part of the cover support part 1b of a portable telephone X1. As shown in FIG. 6, the changeover switch 25 is pushed by the back of the liquid crystal display part 10 when the liquid crystal display part 10 is located at a vertical state, and it is pressed in the cover support part 1b against the spring power of a spring 26 installed in the cover support part 1b.

On the other hand, as shown in FIG. 7 and FIG. 8, since the changeover switch 25 is released from the back of the liquid crystal display part 10 when the liquid crystal display part 10 rotates at 90 degrees to the telephone body 1, it projects to a predetermined position owing to the spring power of the spring 26.

In the above-mentioned composition, when the liquid crystal display part 10 rotates at 90 degrees to the left direction to the telephone body 1, the changeover switch 25 operates (projects). Then, the detection circuit 18 detects the projection signal that the switch changed and detects “so to speak, the lengthwise display screen 12 changes to the longwise display screen 12a”. The detection circuit 18 outputs the detected signal to the CPU 15. Moreover, when the liquid crystal display part 10 is returned to the original state, the changeover switch 25 descends (is pressed).

Therefore, the detection circuit 18 detects a pressing signal that the switch changed and detects “so to speak, the longwise display screen 12 changes to the lengthwise display screen 12a”. The detection circuit 18 outputs the detected signal to the CPU 15. Hereafter, since the control way and functions when the CPU 15 and the like receives the detected signal from the detection circuit 18 is the same as that of the first embodiment, its explanation is omitted.

In addition, although the liquid crystal display part 10 rotates at 90 degrees only to the left direction as a wide screen in the second embodiment, it may rotate either right or left direction. In this case, the detection circuit 18 may detect alternatively the drive signals of the plurality of the changeover switches 25.

A third embodiment of the present invention is shown in FIGS. 10-12. It is distinguished from the first embodiment in that there is no cover in a telephone body 1A. Therefore, since the cover does not pivot the liquid crystal display part 10A, it does not rotate in the intersection state to an input operation part 3A. On the other hand, the input operation part 3A is provided rotatably in the base part 1a of the telephone body 1A through a pivotable shaft 11A, or the telephone body 1A is provided rotatably to the input operation part 3A.

In a portable telephone X2, the base part 1a, formed in the shape of a plate, which supports a general liquid crystal display part 10A with an antenna 13 and the input operation part 3A is connected through the pivot part 2, capable of opening and closing.

Therefore, the telephone body 1A is rotated so that the liquid crystal display part 10A may be located in a left side without changing the position of the input operation part 3A as shown in FIG. 10, when the user operates the scroll key 4 and operation key 5 of the input operation part 3A with the right hand. Of course, when the portable telephone X2 is used as a wide screen, the telephone body 1A turns sideways after the input operation part 3A rotated at 90 degrees. Moreover, in this case, when the left correct key 6 is pushed (if the changeover switch is used, it is operated automatically), the text and figure information which are indicated on the longwise display screen 12a are also indicated in a transverse direction (same as FIG. 5).

In addition, FIG. 11 shows when the user operates the scroll key 4 and operation keys of the input operation part 3A with the left hand. In this case, the telephone body 1A rotates horizontally so that the liquid crystal display part 10A is located in a right side without changing the position of the input operation part 3A. Since the way of the operation is the same as that of the first embodiment, its explanation is omitted.

A fourth embodiment of the present invention is shown in FIGS. 13-16. It is distinguished from the first embodiment in that a lengthwise liquid crystal display part 10B in the fourth embodiment is supported pivotably at one end portion of a support member 30 which is pivoted rotatably by the base plate part 1b of a telephone body 1B through the pivot part 2 although the lengthwise liquid crystal display part 10 of the first embodiment is pivoted by the cover support part 1b which is connected to the base plate part 1a of the of the telephone body.

As shown FIG. 15 and FIG. 16, the support member 30 consists of an engaged support frame part 31 formed in the shape of a channel in section; and right and left axle hole parts 32 and 32 which are projected in a bottom wall of the engaged support frame part 31.

In FIG. 13, one end portion (right end portion) of the lower part of the lengthwise liquid crystal display part 10B is pivoted rotatably by the engaged support frame part 31 through the pivotable shaft 11B which is provided at the engaged support frame part 31. In addition, fitted parts (fit holes, for example) 34 and 34 are formed at another end portion (left end portion) of the engaged support frame part 31, fitting means 35 for fitting when the lower part of the liquid crystal display part 10B engages in the engaged support frame part 31 at a horizontal state. The movable fitting means 35 is formed at the lower part of the liquid crystal display part 10B.

As shown in FIG. 15 and FIG. 16, The movable fitting means 35 is comprised of a sleeve 35a formed in the shape of a cylinder, installing in other end part (free end) at the lower part of the lengthwise liquid crystal display part 10B; a spring 35b (for example, coil spring) installed in the sleeve 35a; and a pair of movable fit pins 35c and 35c, having flanges which has a stopper function, located at the end portions thereof, repelling so as to project the engage part to the outer direction by the spring power of the spring 35b.

Moreover, a stopper 36 is formed at an upper end portion of the input operation part 3B and is formed in the shape of a projection. The stopper 36 can stop to rotate the lengthwise liquid crystal display part 10B at a predetermined position when it rotates at about 90 degrees through the pivotable shaft 11B. In addition, a small hole 37 for straps is formed at the stopper 36.

In the above-mentioned composition, the lengthwise liquid crystal display part 10B rotates at approximately 90 degrees through the pivotable shaft 11B at a fulcrum as shown in FIG. 14. Then, a side wall of the lower part of the lengthwise liquid crystal display part 10B is supported by the stopper 36 so as not to rotate more than the predetermined angle. On the other hand, when the lengthwise liquid crystal display part 10B is returned to the original state, the movable fit pins 35c and 35c contract by the spring power of the spring 35b at first and fit to the fitted parts 34 and 34 of the input operation part 3B, respectively.

Therefore, the portable telephone according to the fourth embodiment has similar advantages to that according to the first embodiment.

By the way, although the folding portable telephone is explained in each embodiment of the present invention, a straight-typed portable telephone is also available. In this case, the input operation part of the portable telephone is provided at a lower part of the base plate part integrally, and the liquid crystal display part is pivoted rotatably at the support part (equivalent to the cover support part) that connected to the base plate part.

As set forth above, the advantages of the invention are as follows:

(1) The lengthwise display screen of the portable telephone can be used also as the longwise display screen. Therefore, a demand of people who think that it is easy to read a character and look at the longwise display screen can be filled.

(2) When the lengthwise display screen is used as the longwise display screen, the informational position and a display setup are indicated correctly corresponding to the longwise display screen by operating automatically or operating just one operation key. Therefore, the operativity is improved efficiently.

(3) The portable telephone in the present invention can be applied by rational composition to the portable telephone that has usually used. That is, the support part or support member is provided at the input operation part, and the lengthwise liquid crystal display part is just rotated at about 90 degrees by hand. Therefore, it is not necessary to complicate the form or appearance structure of the present portable telephone.

What is claimed is:

1. A portable telephone with an input operation part located at a lower part thereof and a lengthwise liquid crystal display part located at an upper part thereof, comprising:
the liquid crystal display part pivots at a support part which connected to a base plate part of a telephone body;
a display screen of the liquid crystal display part, capable of seeing as a longwise display screen when the liquid crystal display part rotates to a horizontal direction at approximately 90 degrees via a pivotable shaft; and
an information indicated visibly on the longwise display screen which is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

2. A portable telephone comprising:
a telephone body having a base plate part which is located below a pivot part, capable of putting a palm on and a cover support part which is located above the pivot part, opening and closing to the base plate part;
an input operation part provided at the base plate part;
a liquid crystal display part which is pivoted on an inner wall of the cover support part, provided a lengthwise display screen as a normal position and a longwise display screen when the liquid crystal display part is rotated at approximately 90 degrees via a pivotable shaft;
a necessary circuit for the telephone;
characterized in that the longwise display screen indicates information is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

3. A portable telephone with an input operation part located at a lower part thereof and a lengthwise liquid crystal display part located at an upper part is thereof through a pivot part, capable of opening and closing, comprising:
one of the input operation part which is provided rotatably in the base plate part of a telephone body through a pivotable shaft and the telephone body which is provided rotatably to the input operation part;
the lengthwise liquid crystal display part with a display screen, capable of seeing as a longwise display screen when the liquid crystal display part is rotated at approximately 90 degrees via a pivotable shaft; and
characterized in that the longwise display screen indicates information is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

4. A portable telephone according to claim 3, wherein the input operation part has at least one correct keys for controlling information elements, being used for inverting and forming so as to read easily information that is indicated on the display screen.

5. A portable telephone with an input operation part located at a lower part thereof and a lengthwise liquid crystal display part located at an upper part thereof, comprising:
the liquid crystal display part which pivots at one end portion of a support member which is supported pivotably by a base plate part of a telephone body;
a display screen of the liquid crystal display part, capable of seeing as a longwise display screen when the liquid crystal display part rotates to a horizontal direction at approximately 90 degrees via a pivotable shaft; and
an information indicated visibly on the longwise display screen which is indicated via a detection circuit for rotation direction of the liquid crystal display; a CPU which receives a detected signal detected by the detection circuit; and a drive circuit which receives a control signal from th CPU and which drives information elements to the liquid crystal display so as to indicate an informational position and display setup correctly corresponding to the display screen as a wide state.

6. A portable telephone according to claim 5, wherein the support member further includes an engaged support frame part; and axle hole parts which are projected in a bottom wall of the engaged support frame part;
characterized in that fitted parts are formed at another end portion of the engaged support frame part, engaged with means for fitting when the lower part of the liquid crystal display part engages in the engaged support frame part.

7. A portable telephone according to claim 5, wherein the an upper end portion of the input operation part forms a stopper which can stop to rotate the lengthwise liquid crystal display part at a predetermined position when it rotates at approximately 90 degrees through the pivotable shaft.
